(19) United States
(12) Patent Application Publication
(10) Pub. No.: US 2005/0126059 A1
(43) Pub. Date: Jun. 16, 2005

(54) Method of creating a gift assemblage

(76) Inventor: Timothy Cobb, Portland, OR (US)

Correspondence Address: TIMOTHY E SIEGEL, 1868 KNAPPS ALLEY, SUITE 206, WEST LINN, OR, 97068, US

(21) Appl. No.: 10/990,104

(22) Filed: Nov. 16, 2004

(51) Int. Cl. G09F 3/00

(52) U.S. Cl. 40/310

(57) ABSTRACT

A method of creating a gift assemblage using a gift item that includes a longitudinal portion and a hanging gift envelope. The gift envelope is decorated in a manner that is thematically related to the gift item and includes an envelope portion and a hanger portion, attached to the envelope portion, the hanger portion defining a through-hole through which the longitudinal portion may be placed. To practice the method, the longitudinal portion is placed through the through-hole.

### BACKGROUND OF THE INVENTION

A person contemplating giving a gift is often faced with the difficult choice of giving a gift certificate, thereby providing the recipient with a great deal of freedom in gift claiming, or giving a specific item chosen by the giver. The gift giver may feel that every time the recipient views the specific item chosen by the giver he or she will remember the moment when it was received from the giver. A memory association of this sort is less likely to be formed with items obtained by way of a gift certificate or gift card. The memory association may be counted on to remind the recipient of the generosity of the giver, leading to warm feelings of appreciation. This is, of course, unless the recipient did not particularly like the gift received. In that event, the recipient may well feel a mild resentment of the fact that the giver did not permit the recipient to choose his or her own gift by providing a gift certificate or card.

One way to avoid the dilemma described above, budget permitting, is to give both a gift card and a definite gift. If the two are somehow tied together, it is more likely that the recipient will form an association between the items received by way of the gift card, the moment of receiving the gift and the giver's generosity. Unfortunately, finding an elegant way to tie together a physical gift with a gift certificate is not necessarily easy. Transparent tape provides a brute force approach, but may present a rather “tacky” look. What is needed is a simple and elegant method of assembling a physical gift and a gift card, designed to make a positive and lasting impression on a gift recipient.

### SUMMARY OF THE INVENTION

In a first separate aspect, the present invention is a method of creating a gift assemblage using a gift item that includes a longitudinal portion and a hanging gift envelope. The gift envelope is decorated in a manner that is thematically related to the gift item and includes an envelope portion and a hanger portion, attached to the envelope portion, the hanger portion defining a through-hole through which the longitudinal portion may be placed. To practice the method, the longitudinal portion is placed through the through-hole.

In a second separate aspect, the present invention is a method of facilitating the assembling of a gift assemblage. In the method, a selection of gift items, each including a longitudinal portion is made available along with a selection of hanging gift envelopes. Each hanging gift envelope has an envelope portion and a hanger portion, attached to the envelope portion, the hanger portion defining a through-hole through which the longitudinal portion may be placed. In addition, a selection gift cards, each sized to fit inside the gift envelopes, is provided. Additionally, at least some of the hanging gift envelopes are thematically related to some of the gift items.

The foregoing and other objectives, features and advantages of the invention will be more readily understood upon consideration of the following detailed description of the preferred embodiment(s), taken in conjunction with the accompanying drawings.

### BRIEF DESCRIPTION OF THE DRAWINGS

FIG. 1 is a perspective view of a gift assemblage featuring wine, according to the present invention.

FIG. 2A is a front view of the hanging gift envelope of the gift assemblage of FIG. 1.

FIG. 2B is a rear view of the hanging gift envelope of FIG. 2A.

FIG. 3 is a perspective view of a gift assemblage featuring a potted plant, according to the present invention.

FIG. 4 is a perspective view of a gift assemblage featuring a bouquet of flowers, according to the present invention.

FIG. 5 is a perspective view of a gift assemblage featuring a candy cane, according to the present invention.

FIG. 6 is a perspective view of a gift assemblage featuring a trowel, according to the present invention.

FIG. 7 is a perspective view of a gift assemblage featuring a fishing pole, according to the present invention.

### DETAILED DESCRIPTION OF THE PREFERRED EMBODIMENT(S)

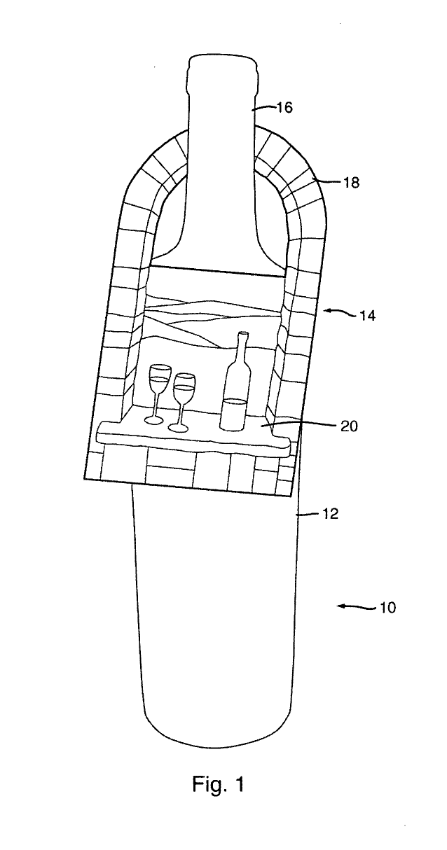

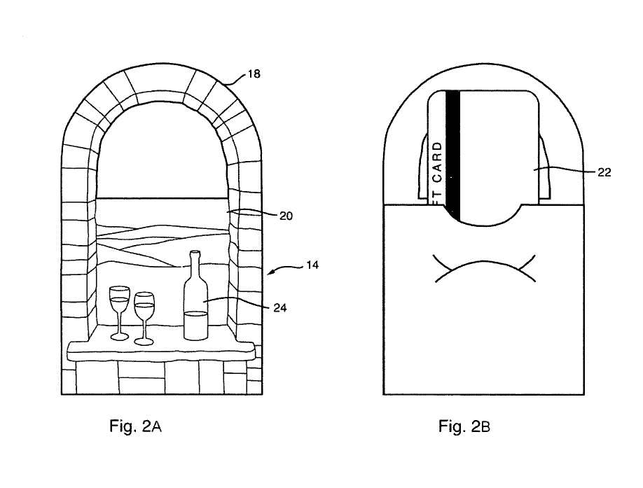

Referring to FIGS. 1 and 2, in a preferred method of practicing the present invention, a gift assemblage 10 is created in which a bottle of wine 12 is adorned with a hanging gift envelope 14, placed about a neck 16 of the bottle 12. More specifically a hanger portion 18 is placed about the bottle neck 16. An envelope portion 20 contains a gift card 22, which may be good toward the purchase of further wine and/or cheese, to go with the wine. Envelope portion is decorated with wine related imagery 24, while advantage is taken of the natural arch-shape of the hanger portion 18, by emblazoning it with the image of an arch.

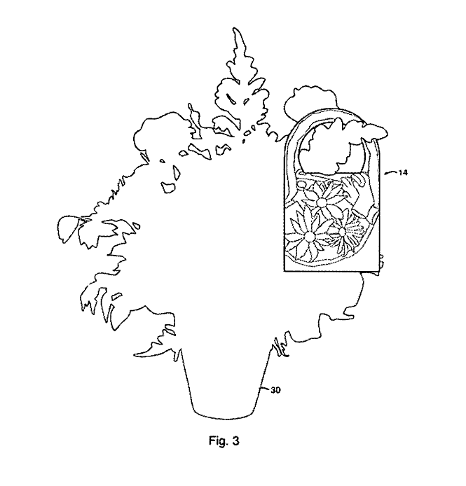

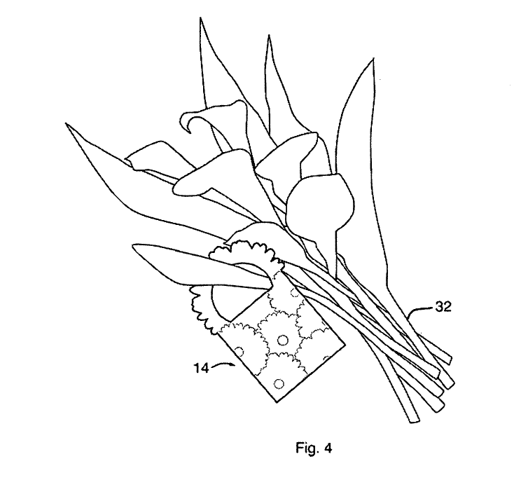

Referring to FIGS. 3 and 4, plant material such as a potted plant 30 or a floral bouquet 32 may be used as the central item of the gift assemblage. In this instance hanging envelope 14 is hung from a plant leaf or stem. The gift card 22 may be good for the purchase of further plants or flowers. Also, the potted plant 30 hanging envelope 14 incorporates a gardener's tool holder design in which the hanger 18 is decorated as the tool holder strap. The envelope 14 for the bouquet 32 shows a flower theme, with the hanger 18 incorporating the natural arc of a flower's petals, as its design.

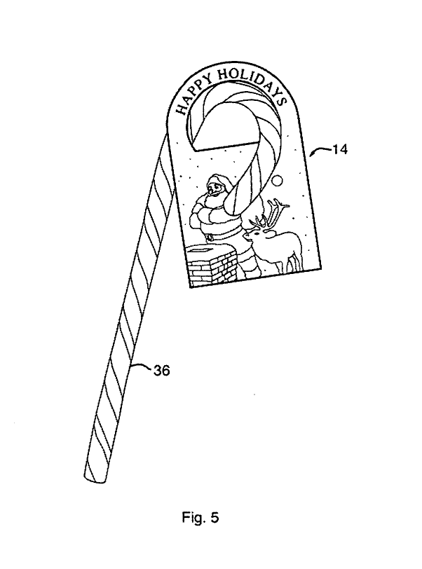

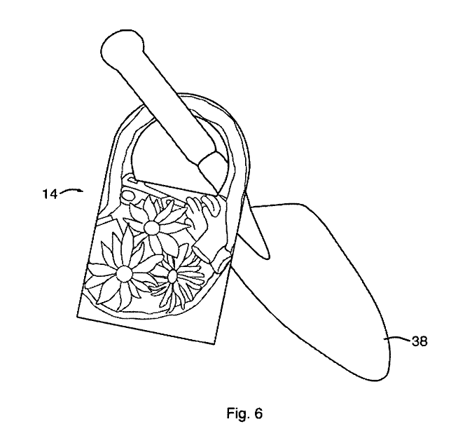

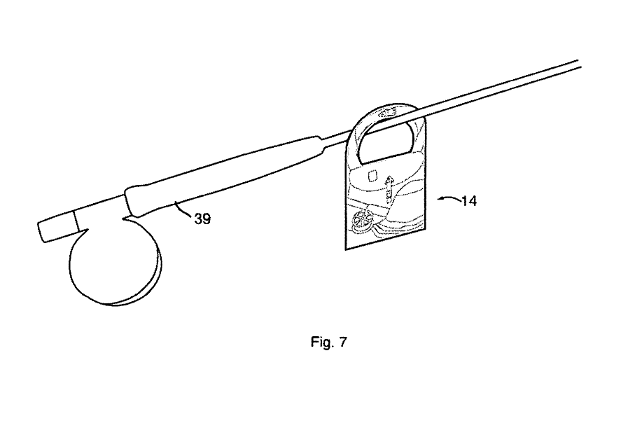

Referring to FIG. 5, a Santa Claus theme hanging envelope is placed on a candy cane 36. FIG. 6 shows an envelope 14, just like the envelope of FIG. 3, this time associated with a trowel 38. FIG. 7 shows a fishing pole 39 and an envelope 14 having a fisherman's basket design, with the hanger 18 being decorated as the handle of the fisherman's basket.

The terms and expressions that have been employed in the foregoing specification are used as terms of description and not of limitation. There is no intention, in the use of such terms and expressions, of excluding equivalents of the features shown and described or portions thereof; it being recognized that the scope of the invention is defined and limited only by the claims which follow.

1. A method of creating a gift assemblage, comprising:
(a) providing a gift item including a longitudinal portion; and
(b) providing a hanging gift envelope having:
(i) an envelope portion; and
(ii) a hanger portion, attached to said envelope portion, said hanger portion defining a through-hole through which said longitudinal portion may be placed;
(c) placing said longitudinal portion through said through-hole; and
(d) wherein said hanging gift envelope is decorated in a manner that is thematically related to said gift item.

2. The method of claim 1 wherein said gift item is a bottle of wine and said hanging gift envelope bears imagery related to wine.

3. The method of claim 1 wherein said gift item is plant matter and said hanging gift envelope bears imagery related to plants.

4. The method of claim 3 wherein said plant matter is a flower arrangement and said hanging gift envelope bears flower imagery.

5. The method of claim 3 wherein said plant matter is a potted plant and said hanging gift envelope bears plant imagery.

6. The method of claim 1 wherein said gift item is an article of fishing equipment and said hanging gift envelope bears the image of a fisherman's kreel having a handle and said hanger of said hanging gift envelope bears an image of said kreel handle.

7. The method of claim 1 wherein said gift item is an article of fishing equipment and said hanging gift envelope bears the image of a gardener's tool holder having a strap and said hanger of said hanging gift envelope bears an image of said strap of said gardener's tool holder.

8. The method of claim 1 wherein said gift card is good for purchasing additional items, similar to said gift items.

9. The method of claim 8 wherein said gift item is a bottle of wine and said gift card is good for purchasing additional bottles of wine.

10. The method of claim 1 wherein said hanger portion is decorated with a design of a naturally arch-shaped item.

11. The method of claim 10 wherein said naturally arch-shaped item is an arch.

12. The method of claim 10 wherein said hanger portion is decorated with a floral wreath design.

13. A method of facilitating the assembling of a gift assemblage, comprising:
(a) providing a selection of gift items, each including a longitudinal portion; and
(b) providing a selection of hanging gift envelopes, each having:
(i) an envelope portion; and
(ii) a hanger portion, attached to said envelope portion, said hanger portion defining a through-hole through which said longitudinal portion may be placed;
(c) providing a selection gift cards, each sized to fit inside said gift envelopes; and
(d) wherein at least some of said hanging gift envelopes are thematically related to some of said gift items.

14. The method of claim 13 wherein at least one of said gift items is a bottle of wine and at least one of said hanging gift envelopes bears imagery related to wine.

15. The method of claim 13 wherein at least one of said gift items is plant matter and at least one of said hanging gift envelopes bears imagery related to plants.

16. The method of claim 15 wherein said plant matter is a flower arrangement and said hanging gift envelope bears flower imagery.

17. The method of claim 15 wherein said plant matter is a potted plant and said hanging gift envelope bears plant imagery.

18. The method of claim 13 wherein said gift item is an article of fishing equipment and said hanging gift envelope bears the image of a fisherman's kreel having a handle and said hanger of said hanging gift envelope bears an image of said kreel handle.

19. The method of claim 13 wherein said gift item is an article of fishing equipment and said hanging gift envelope bears the image of a gardener's tool holder having a strap and said hanger of said hanging gift envelope bears an image of said strap of said gardener's tool holder.

20. The method of claim 13 wherein said gift card is good for purchasing additional items, similar to at least one of said gift items.

21. The method of claim 20 wherein at least one of said gift item is a bottle of wine and said gift card is good for purchasing additional bottles of wine.
